(19) United States
(12) Patent Application Publication
(10) Pub. No.: US 2026/0366547 A1
(43) Pub. Date: Nov. 19, 2026

(54) Clip

(71) Applicant: Illinois Tool Works Inc., Glenview, IL (US)

(72) Inventor: Maxence Trap, L'Isle Adam (FR)

(21) Appl. No.: 19/664,208

(22) Filed: Apr. 30, 2026

(30) Foreign Application Priority Data
May 16, 2025 (EP) 25315166.6
Apr. 10, 2026 (FR) 2604643

(51) Int. Cl. F16B 2/22

(52) U.S. Cl. CPC F16B 2/22

(57) ABSTRACT

The clip includes a body defining an interior and an exterior, at least one finger arranged on the exterior, and one or more arms disposed within the interior. The at least one finger includes a finger tip bent relative to the finger to form a hook configured to engage the frame. The arms are resilient and configured to engage a panel after insertion of the clip into the frame. The clip may be formed from plastic and may have a substantially U-shaped or V-shaped body. The configuration provides improved retention within the frame, resists collapse during installation, and facilitates secure attachment of the panel.

### RELATED APPLICATIONS

The present application claims the benefit of German Patent Application No. 25315166.6, filed May 16, 2025, and French Patent Application No. 2604643, filed Apr. 10, 2026, each titled “Clip,” the contents of which are hereby incorporated by reference.

### BACKGROUND

The disclosure relates to a clip suitable to attach a panel to a frame in e.g. a vehicle. Conventional clips used to secure panels to frames, particularly in vehicles, may be formed from metal or plastic. Some existing clips can unintentionally fall through apertures in a frame during installation, leading to assembly inefficiencies and potential noise issues, such as rattling or buzzing. Metal clips may also scratch or damage adjacent components, especially plastic panels. Accordingly, there is a need for improved clips that provide secure retention to a frame, resist collapse during installation, and reduce the risk of noise and component damage.

### SUMMARY

The present disclosure relates generally to a clip, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates a clip.

FIG. 2A illustrates a clip in a first perspective view.

FIG. 2B illustrates a clip in a second perspective view.

FIG. 3 illustrates an exploded view of a clipping system.

FIG. 4 illustrates a frame.

FIG. 5 illustrates the clipping system after mounting.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples, and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The words ‘inner’, ‘inwardly’, ‘outer’ and ‘outwardly’ refer to directions toward and away from, respectively, a designated centreline or a geometric centre of an element being described (e.g. central axis), the particular meaning being readily apparent from the context of the description.

Further, as used herein, the terms ‘connected’, ‘attached’, ‘coupled’ and ‘mounted’ are intended to include direct connections between two members without any other members interposed therebetween, as well as, indirect connections between members in which one or more other members are interposed therebetween. The terminology includes the words specifically mentioned above, derivatives thereof, and words of similar import.

Further, unless otherwise specified, the use of ordinal adjectives, such as, “first”, “second” and “third” etc. merely indicate that different instances of like objects are being referred to and are not intended to imply that the objects so described must be in a given sequence, either temporally, spatially, in ranking or in any other manner.

Like reference numerals are used to depict like features throughout.

In an example, the disclosure relates to a clip suitable to attach a panel to a frame in, e.g., a vehicle, the clip comprising: a body defining an interior and an exterior, at least one finger arranged on the exterior, the at least one finger comprising at least one finger tip, wherein the at least one finger tip is bent relative to the at least one finger. The finger tip may therefore form a hook that is configured to grasp the frame, which is advantageous.

The clip according to the disclosure may comprise one or more of the following features, taken separately or in combination with each other:

In some examples, the at least one finger tip is bent in a direction towards a base of the body.

In some examples, the at least one finger tip is shaped to grasp a crevice of said frame.

In some examples, the at least one finger tip is shaped to include a retaining edge, preferably said retaining edge is defined by two adjacent perpendicular faces of said at least one finger tip.

In some examples, the at least one finger is arranged to resist collapse of the interior.

In some examples, the clip further comprises one or more arms located within the interior of the body.

In some examples, the one or more arms extend from a base of the body.

In some examples, the one or more arms are hook-shaped.

In some examples, the one or more arms point towards the interior.

In some examples, the one or more arms each comprise a free end, and optionally wherein the free end comprises a clubbed cross section.

In some examples, the one or more arms are resilient and remain resilient once the clip is inserted into the frame, such that the one or more arms are arranged to grasp the panel after the clip is inserted into the frame.

In some examples, the clip comprises plastic and/or is formed from plastic.

In some examples, the clip and/or the body is substantially V-shaped or U-shaped.

A reinforcement rib can be provided towards a base of the body.

In some examples, the body comprises at least one shoulder arranged adjacent the at least one finger.

A distance between the at least one shoulder and the at least one finger can correspond to a frame thickness.

In some examples, the at least one finger tip points generally towards the at least one shoulder.

In some examples, the at least one finger tip is L-shaped.

In another example, the disclosure further relates to a clip suitable to attach a panel to a frame in, e.g., a vehicle, the clip comprising: a body defining an interior and an exterior, one or more arms located within the interior of the body.

The clip according to the disclosure may comprise one or more of the following features, taken separately or in combination with each other, where: (1) one or more arms extend from a base of the body; (2) one or more arms are hook-shaped; (3) one or more arms point towards the interior; (4) one or more arms each comprise a free end, and optionally wherein the free end comprises a clubbed cross section; and (5) one or more arms are resilient and remain resilient once the clip is inserted into the frame, such that the one or more arms are arranged to grasp the panel after the clip is inserted into the frame.

The clip can further comprise at least one finger arranged on the exterior, the at least one finger comprising at least one finger tip, wherein the at least one finger tip is bent relative to the at least one finger. The finger tip may therefore form a hook that is configured to grasp the frame, which is advantageous.

The at least one finger tip can be bent in a direction towards a base of the body.

The at least one finger tip can be shaped to grasp a crevice of said frame.

The at least one finger tip can be shaped to include a retaining edge, preferably said retaining edge is defined by two adjacent perpendicular faces of said at least one finger tip.

The at least one finger can be arranged to resist collapse of the interior.

The clip comprises plastic and/or is formed from plastic.

The clip and/or the body can be substantially V-shaped or U-shaped.

A reinforcement rib can be provided towards a base of the body.

The body can comprise at least one shoulder arranged adjacent the at least one finger.

A distance between the at least one shoulder and the at least one finger can correspond to a frame thickness.

In some examples, the at least one finger tip points generally towards the at least one shoulder.

In some examples, the at least one finger tip is L-shaped.

The disclosure further relates to a U-shaped or V-shaped clip or body comprising two sides having first ends connected together by the base, and second ends opposed to the first ends and remote from one another. Said at least one finger may be located at said second ends. Each of said sides may comprise a U-shaped slot defining an arm. Preferably, each arm is connected to the base and extends from one of the first ends towards one of the second ends. Preferably, each arm has a portion opposed to the base which is bent so as to be U-, V-, or C-shaped. Said arms include inner protrusions which are facing each other and which are configured to cooperate by snap fitting with a leg of a panel. Said clip or body may comprise one or more of the features listed above.

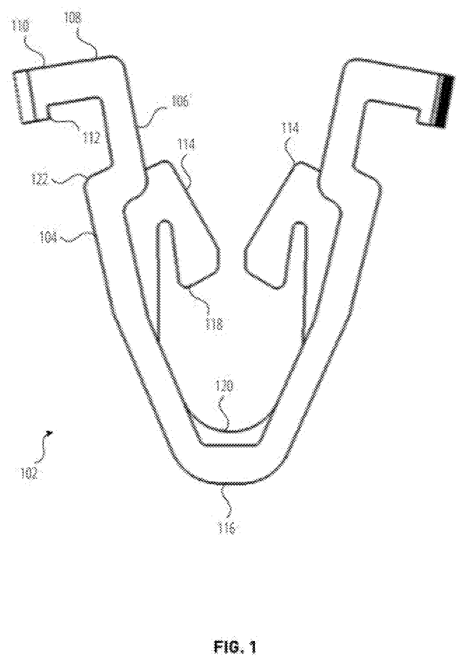

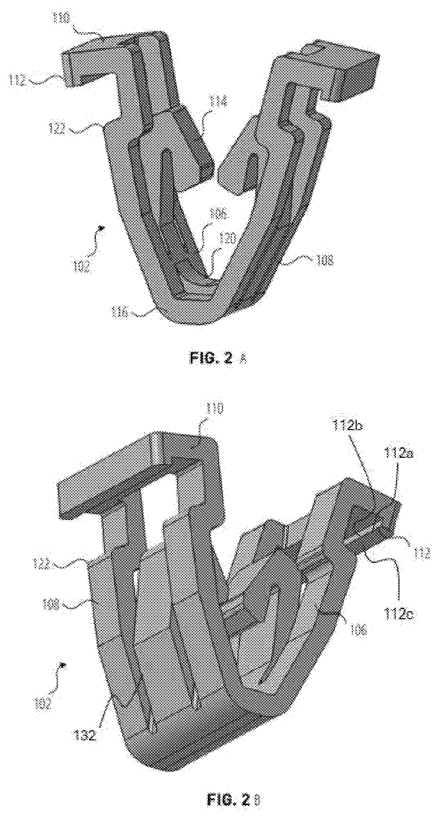

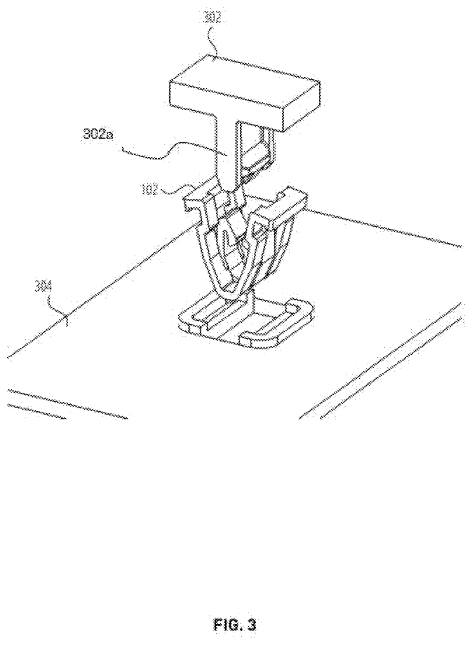

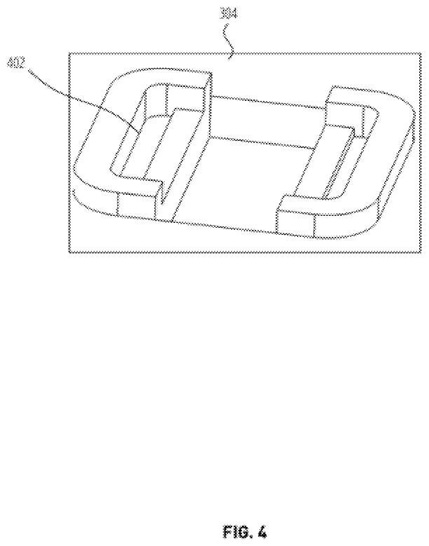

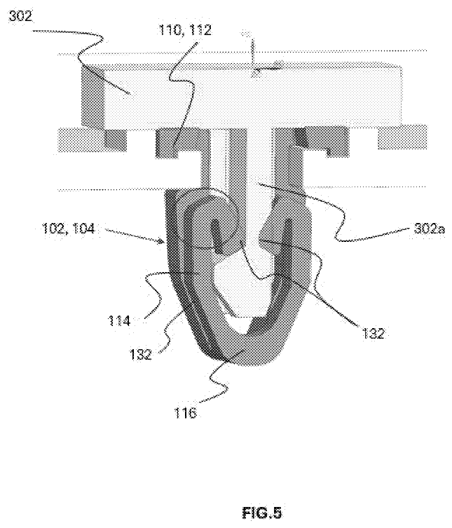

FIG. 1 shows a clip 102 that is suitable to attach a panel 302 to a frame 304 in a vehicle, for example. Here the frame may be a body-in-white and the panel may be a trim panel such as a dashboard. The panel 302 normally includes a leg 302a which is inserted into, and grasped by, the clip (see FIG. 5).

The clip 102 comprises a body 104. The body is typically, but not limited to, a U or V shape. The body 104 defines an interior 106 and an exterior 108. Here, interior 106 means the inside region of the clip. This does not mean that the interior is bounded on all sides by the body. The interior may be considered a volume defined by the body where one part of the body is disposed in opposition to another part of the body. The interior can be considered to be the sides of the body which face towards the interior. The exterior can be considered to be the sides of the body which face away from the interior. The interior comprises those features of the clip arranged to interface with the panel. The exterior of the clip comprises those features of the clip arranged to interface with the frame.

At least one finger 110 is arranged on the exterior; in other words, the finger 110 is located on the body so that it may interface with the frame. The at least one finger 110 comprises at least one finger tip 112. The at least one finger tip 112 is bent relative to the at least one finger 110. The at least one finger tip 112 may therefore form a hook or act as a hook that is configured to grasp said frame. This is so that the finger 110 makes a first point of contact with the frame and the finger tip 112 makes a second point of contact with the frame. The first and second points of contact are arranged to resist dislocation forces in different directions. The first point of contact may resist pull-through of the clip through the frame, and the second point of contact may resist collapse of the clip, for example. Here, collapse of the clip means a reduction in volume of the interior. Where the clip body is substantially U-shaped with the fingers located upon the external serifs of the “U,” collapse may entail urging one arm of the U towards the other arm of the U.

The at least one finger tip may be bent in a direction towards a base 116 of the body, i.e., in use into a Z or thickness direction of the panel.

The clip 102 or body 104 comprises two sides having first ends connected together by the base 116, and second ends opposed to the first ends and remote from one another. The at least one finger 110 may be located at said second ends.

Optionally, the at least one finger tip 112 is shaped to grasp a crevice 402 of a frame 304 in order to, e.g., provide the second point of contact as described above. The finger tip 112 locks the clip to the frame 304 and prevents the clip from unintentionally collapsing and falling through an aperture in the frame in which the clip is located. This maintains the clip in position ready for use in the frame 304 (i.e., to subsequently have a panel attached thereto). As such, the at least one finger can be arranged to resist collapse of the interior.

The at least one finger tip 112 may be L-shaped.

The at least one finger tip 112 may be shaped to include a retaining edge 112a; preferably, said retaining edge 112a is defined by two adjacent perpendicular faces 112b, 112c of said at least one finger tip 112.

The clip can be provided with one or more arms 114 located within the interior of the body in order to grasp a suitable feature of a panel and thereby attach a panel to a frame via the clip.

The one or more arms 114 may extend from the base 116 of the body 104 (i.e., the inflection in the letter U can be considered the base where the clip is U-shaped). The one or more arms may be hook-shaped so as to apply a pinch grip to a panel feature. The arms may be formed of a resilient material to provide this.

The one or more arms 114 may point towards the interior. Where the arms are hook-shaped, a point of the hook may be arranged to point towards the interior even if the length of the arm does not.

The one or more arms 114 may each comprise a free end 118 to interface with a feature of a panel. Optionally, the free end comprises a clubbed cross section or a trapezoidal cross section such that the free end comprises one or more bearing faces to increase a contact surface area with a panel.

The one or more arms 114 may be resilient and remain resilient once the clip is inserted into a frame, such that the one or more arms are arranged to grasp a panel after the clip is inserted into a frame. The clip may therefore be inserted into a frame and hold its position on the frame for a panel to subsequently be attached. The attachment to the frame does not adversely affect the ability of the clip to be attached to a panel. The resilience of the clip may also allow for the clip to be reusable and also to have a wide tolerance to panel aperture size or panel feature variation and still make a secure fastening.

Each of said sides of the body may comprise a U-shaped slot 130 defining the arm 114. Preferably, each arm 114 is connected to the base 116 and extends from one of said first ends towards one of said second ends. Preferably, each arm 114 has a portion opposed to the base which is bent so as to be U-, V-, or C-shaped.

The arms 114 include inner protrusions 132 which are facing each other and which are configured to cooperate by snap fitting with the leg 302a of the panel 302 (FIG. 5).

The clip 102 comprises plastic and may be entirely formed from plastic. Any suitably resilient plastic or polymer may be used provided the required material properties as discussed above are provided.

The body 104 of the clip 102 may be any suitable shape for the clip to perform the function of providing an interface between the panel and the frame. An example body shape is a substantially U shape.

A reinforcement rib 120 is provided towards a base 116 of the body 104 to resist breakage by flexing of the body during use (either fitment or during the lifetime of the parts fixed together, e.g., to protect from vibrations).

The body 104 may further comprise at least one shoulder 122 that is arranged adjacent the at least one finger. A distance between the at least one shoulder and the at least one finger corresponds to a frame thickness. The at least one finger tip may point generally towards the at least one shoulder. This is so the frame may sit between the shoulder and the finger in order for the clip to resist unintentional removal from the frame 304.

A typical insertion force may be 3 daN or less. A typical retention force may be 7 daN or greater.

The clip of the present disclosure is advantageous in that the clip does not fall through the frame, unlike metal prior art. The finger and finger tip resist this. Prior art clips that fall through are problematic in creating buzzing noises in a vehicle. Metal clips also risk scratching plastic panels, which is mitigated by using a plastic clip.

It will be appreciated by persons skilled in the art that the above detailed examples have been described by way of example only and not in any limiting sense, and that various alterations and modifications are possible without departing from the scope of the disclosure as defined by the appended claims. Various modifications to the detailed examples described above are possible.

Through the description and claims of this specification, the words “comprise” and “contain” and variations of them mean “including but not limited to,” and they are not intended to (and do not) exclude other moieties, additives, components, integers, or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties, or groups described in conjunction with a particular aspect, embodiment, or example of the disclosure are to be understood to be applicable to any other aspect, embodiment, or example described herein unless incompatible therewith. All of the features disclosed in this specification (including any accompanying claims, abstract, and drawings), and/or all of the steps of any method or process so disclosed, may be combined in any combination, except combinations where at least some of such features and/or steps are mutually exclusive. The disclosure is not restricted to the details of any foregoing embodiments. The disclosure extends to any novel one, or any novel combination, of the features disclosed in this specification (including any accompanying claims, abstract, or drawings), or to any novel one, or any novel combination, of the steps of any method or process so disclosed.

Therefore, while the present method and/or system have been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, blocks and/or components of disclosed examples may be combined, divided, rearranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A clip (102), suitable to attach a panel (302) to a frame (304) in e.g. a vehicle, the clip comprising:
a body (104) defining an interior (106) and an exterior (108); and
at least one finger (110) arranged on the exterior, the at least one finger comprising at least one finger tip (112), wherein the at least one finger tip is bent relative to the at least one finger so as to form a hook configured to grasp said frame (304).

2. The clip of claim 1, wherein the at least one finger tip (112) is bent in a direction towards a base (116) of the body.

3. The clip of claim 1, wherein the at least one finger tip (112) is shaped to include a retaining edge (112a), preferably said retaining edge (112a) is defined by two adjacent perpendicular faces (112b, 112c) of said at least one finger tip (112).

4. The clip of claim 1, wherein the at least one finger (110) is arranged to resist collapse of the interior.

5. The clip of claim 1, further comprising one or more arms (114) located within the interior of the body (104).

6. The clip of claim 5, wherein the one or more arms (114) extend from a base (116) of the body.

7. The clip of claim 5, wherein the one or more arms (114) are hook shaped; and/or
the one or more arms (114) point towards the interior; and/or
the one or more arms (114) each comprise a free end (118), and optionally wherein the free end comprises a clubbed cross section, and/or
the one or more arms (114) are resilient and remain resilient once the clip is inserted into the frame, such that the one or more arms (114) are arranged to grasp the panel after the clip is inserted into the frame (304).

8. The clip of claim 1, wherein:
the clip comprises plastic, and further optionally wherein the clip is formed from plastic.

9. The clip of claim 1, wherein:
the body is substantially U shaped; and/or
a reinforcement rib (120) is provided towards a base (116) of the body.

10. The clip of claim 1, wherein the body (116) comprises at least one shoulder (122) arranged adjacent the at least one finger (110), and optionally, a distance between the at least one shoulder (122) and the at least one finger (110) corresponds to a frame thickness, and further optionally wherein the at least one finger tip (112) points generally towards the at least one shoulder (122).

11. A clip for attaching a panel to a frame, the clip comprising:
a body defining an interior and an exterior, the body including a base and first and second sides extending from the base;
at least one finger disposed on the exterior of the body, the at least one finger including a finger tip bent relative to the at least one finger so as to form a hook configured to engage the frame; and
one or more arms disposed within the interior of the body and extending from the base, the one or more arms being resilient and configured to engage the panel after the clip is inserted into the frame,
wherein the finger tip is configured to provide a first engagement with the frame and the at least one finger is configured to resist collapse of the body while the one or more arms retain the panel within the interior.
